(19) United States
(12) Patent Application Publication
(10) Pub. No.: US 2023/0347973 A1
(43) Pub. Date: Nov. 2, 2023

(54) AGRICULTURAL HIGH-CLEARANCE VEHICLE WITH IMPROVED STEERING AND SUSPENSION COUPLING

(71) Applicant: EXEL INDUSTRIES, Epernay (FR)

(72) Inventor: Anthony Boge, Hautvillers (FR)

(21) Appl. No.: 18/308,081

(22) Filed: Apr. 27, 2023

(30) Foreign Application Priority Data
Apr. 28, 2022 (FR) 2204017

(51) Int. Cl. B62D 7/08; A01B 69/00; B62D 7/16; B60G 3/01

(52) U.S. Cl. CPC B62D 7/08; A01B 69/007; B62D 7/163; B60G 3/01; B60G 2300/08; B60G 15/12

(57) ABSTRACT

The present invention relates to a motorized machine having a chassis, a suspension system mechanically coupled on the one hand to a wheel of the motorized machine and on the other hand to the chassis, and a steering system configured to transmit the steering to said wheel of the motorized machine through the suspension system, the steering system being in a slide-type mechanical connection with the suspension system along the axis of the suspension system.

### TECHNICAL FIELD

The present invention relates to the field of motorized machinery, in particular for agricultural use.

In particular, the present invention relates to an agricultural machine, for example a high-clearance machine for vine crops, having improved handling.

### BACKGROUND

As is known, an agricultural machine generally comprises a chassis on which wheels are mounted, a cab to accommodate a driver, and tools mounted on the chassis, for example tools for spraying products, sizing crops, harvesting, or cultivating the ground.

In the context of agricultural machinery, one of the challenges lies in the handling of the agricultural machine by the operator. Typically, a four-wheeled agricultural machine comprises a steering system configured to transmit the steering to the two front wheels for steering and controlling the vehicle. In addition, as the front wheels are traditionally located under the cab, they are usually each fitted with a suspension system, so as to dampen the vibrations of the wheels transmitted to the cab.

It is known to design the steering and wheel suspension so that the steering is transmitted to the corresponding wheel via the suspension system. In particular, the steering system may comprise a steering cylinder driving a steering yoke centered with respect to the two front wheels. Two steering rods then connect the steering yoke respectively to the suspension systems of each of the two front wheels. In particular, each of the two steering rods is connected to the corresponding suspension system via a ball-joint connection. So, when the suspension is activated, for example when the machine is operating on terrain with uneven inclination or relief, the steering rod, driven vertically by the suspension system, will cause an additional steering lock of the corresponding wheel.

As a result, the travel of the suspension influences the steering lock of the wheels, which may lead to uncontrolled steering lock of the wheels and a loss of wheel adherence, e.g. in a curve. In particular, when the agricultural machine is driving in a straight line, following activation of the suspension, the wheels may no longer be parallel to each other. In this case, the driver is required to straighten the wheels of the vehicle regularly, negatively affecting the vehicle's handling. In addition, the Jeantaud king-pin condition, a geometric condition on the wheels during a steering lock in order to avoid a wheel shifting phenomenon, may no longer be met.

In response to these disadvantages, the present invention provides a motorized machine of which at least one wheel has a steering system and a suspension system kinematically connected to each other so as to limit the impact of the travel of the suspension on the steering of the wheel. Thus, the present invention provides the considerable advantage of enabling improved control of the agricultural machine in a straight line and in curves.

### SUMMARY

More precisely, the invention relates to a motorized machine comprising a chassis, a suspension system mechanically coupled on the one hand to a wheel of the motorized machine and on the other hand to the chassis, and a steering system configured to transmit the steering to said wheel of the motorized machine through the suspension system, the steering system being in a slide-type mechanical connection with the suspension system along the axis of the suspension system.

According to one embodiment, the axis of the suspension system is substantially vertical.

According to one embodiment, the steering system comprises a main connecting rod in a pivot-type mechanical connection with the chassis, a deflector rod mechanically coupled to the main connecting rod and oriented according to the axis of the suspension system, and a secondary connecting rod on the one hand mechanically coupled to the suspension system and on the other hand in a sliding pivot-type mechanical connection with the deflector rod, so that the steering system is in a slide-type mechanical connection with suspension system.

Advantageously, the suspension system comprises a suspension pivot rod and a guide sleeve configured to receive the suspension pivot rod, the guide sleeve being mechanically coupled to the chassis and being in a pivot-type mechanical connection with the main connecting rod, the suspension pivot rod being furthermore mechanically coupled on the one hand to the corresponding wheel and on the other hand to the secondary connecting rod of the steering system.

In particular, the motorized machine may comprise a steering cylinder, the steering system comprising a steering rod in a ball joint-type mechanical connection with the main connecting rod, and the steering cylinder being configured to transmit the steering to the main connecting rod through the steering rod.

According to one embodiment, the motorized machine forms a four-wheel motorized machine, the motorized machine comprising two suspension systems, two steering systems, each of the two suspension systems and each of the two steering systems being respectively associated with one and the other of the two front wheels of the motorized machine.

In particular, the steering cylinder may consist of a double rod cylinder, each of the steering systems, associated respectively with one and the other of the two front wheels of the motorized machine, comprising a connecting part mechanically connecting the double rod cylinder to the corresponding steering rod.

Advantageously, the steering cylinder is substantially arranged parallel to a shaft connecting the two front wheels of the motorized machine.

The motorized machine according to the invention forms, for example, a high-clearance machine for vine crops.

### BRIEF DESCRIPTION OF THE DRAWINGS

The invention will be better understood upon reading the following description, given solely as an example, and by referring to the accompanying figures, given as non-limiting examples, wherein identical references are given to similar objects and wherein:

FIG. 1 is a schematic representation of a perspective view of an example of a motorized machine according to an embodiment of the invention;

FIGS. 2 and 3 are schematic representations of a partial front view of the example of a motorized machine according to an embodiment of the invention, respectively when the suspension systems are in the neutral position and when the suspension systems are in the active position;

FIG. 4 is a schematic representation of a partial sectional view of the example of a motorized machine according to an embodiment of the invention;

FIGS. 5 and 6 are schematic representations of a partial top view of the example of a motorized machine according to an embodiment of the invention, respectively when the wheels are straight and when the wheels are in steering lock;

FIG. 7 is a schematic representation of a partial top view of another example of a motorized machine according to an embodiment of the invention.

It should be noted that the figures disclose the invention in detail in order to implement the invention; said figures may of course be used to better define the invention where applicable.

### DETAILED DESCRIPTION

The invention relates to a motorized machine, in particular of the agricultural high-clearance type for vine crops, in particular a four-wheel motorized machine. In addition, the motorized machine may be a self-propelled or towed vehicle.

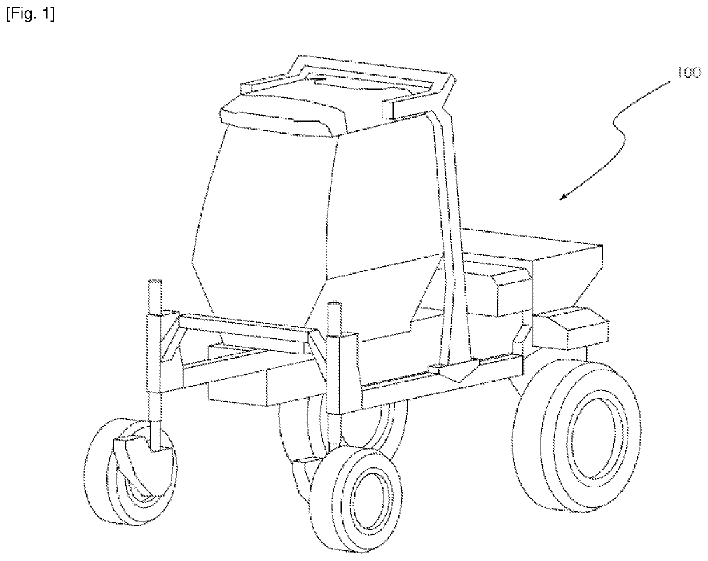

FIG. 1 shows a perspective view of an example of the motorized machine 100 according to the invention. The motorized machine 100 comprises a chassis 30. In particular, tools may be attached to the chassis 30 of the machine, for example, tools for spraying products, cultivating the ground, or sizing crops.

In addition, the motorized machine 100 may comprise a cab (not shown in the figures), in particular mounted on the front axle of the machine. “Front axle” means a set of mechanical members located in the front portion of the machine, including, inter alia, the front wheels, and the mechanical members for the steering and suspension of the wheels. The cabin is configured to accommodate a machine operator, of which the present invention aims to improve driving handling.

The motorized machine is generally equipped with a combustion engine, an electric motor or an engine powered by a hydrogen fuel cell configured to supply a hydraulic pump. The hydraulic pump then drives in turn at least one hydraulic motor, preferably two hydraulic motors. Each hydraulic motor is arranged at the hub of one of the wheels of the machine, so as to drive the corresponding wheel in rotation, known as the drive wheel. Such a hydraulic motor built into the wheel is commonly referred to as an “in-wheel” hydraulic motor. The hydraulic motor may advantageously comprise a built-in brake system. The hydraulic motor(s) are then connected to the hydraulic pump through a hydraulic circuit, having for example hose lines.

The present invention also relates to a guide wheel and suspended for the motorized machine, allowing improved handling of the machine. In the remainder of the description, the invention will be described in the non-limiting context of a motorized machine having two suspended front guide wheels. Thus, particular attention will be paid to the front axle of the motorized machine.

In addition, the two front wheels are preferably drive wheels. Where applicable the two front wheels each have an associated hydraulic motor. Nonetheless, the invention may also apply to non-drive wheels.

For the sake of simplification, the mechanical arrangement of the various members will be detailed solely for one suspended guide wheel of the motorized machine, although the invention is preferably implemented on the two front wheels of the machine.

The motorized machine comprises a suspension system 10 associated with the corresponding wheel 40, in particular making it possible to dampen the vibrations of the corresponding wheel 40. Preferably, the motorized machine comprises two suspension systems 10, each one of the two suspension systems 10 being associated with one of the two front wheels of the machine.

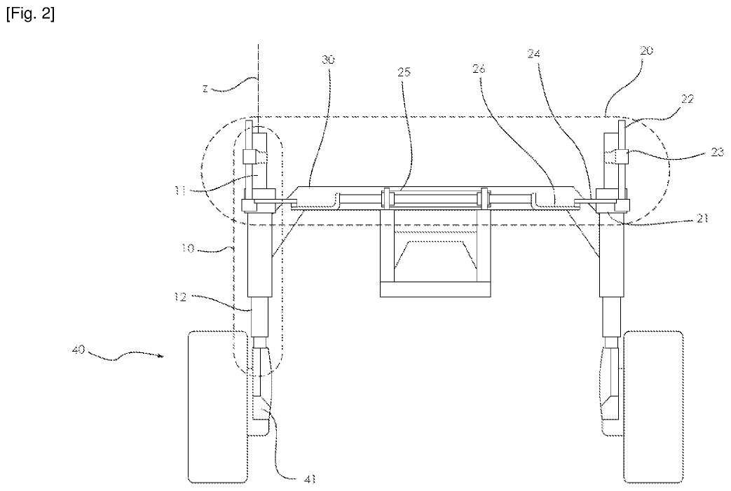

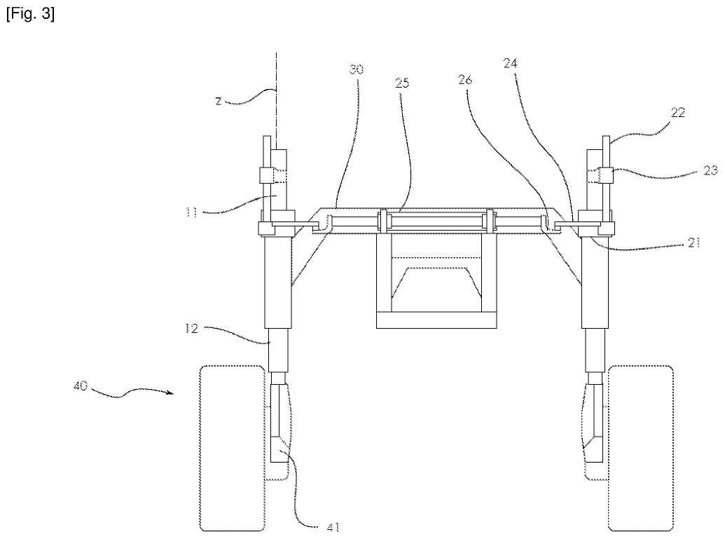

FIGS. 2 and 3 show an example of the motorized machine according to the invention seen from the front respectively when the suspension system 10 is in the neutral position (FIG. 2) and when the suspension system 10 is in the active position (FIG. 3). The neutral position corresponds to a position of the suspension system when the motorized machine is positioned flat on a terrain. Preferably, the neutral position may correspond to the mid-travel of the suspension system 10. However, the suspension system 10 may have another neutral position, the adjustment of the neutral position advantageously making it possible to adjust the height of the front of the chassis 30, so as to adapt the height of a tool such as a trimmer, for example. The active position of the suspension system then corresponds to a position that is not the neutral position.

When both front wheels are suspended, the two respective suspension systems may be independent or dependent of each other. It should be noted that dependent suspension systems have the advantage of being more robust.

The suspension system 10 is mechanically coupled, on the one hand, to the corresponding wheel 40 of the motorized machine and, on the other hand, to the chassis 30 of the motorized machine. “Mechanically coupled” means that at least a portion of the respective elements are integral with each other.

In addition, the motorized machine comprises a steering system 20 configured to transmit the steering to the corresponding wheel 40 of the motorized machine through the suspension system 10. In other words, the suspension system 10 is used to transmit the steering to the corresponding wheel 40.

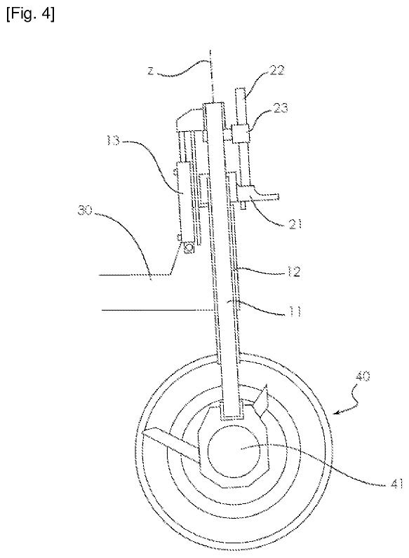

FIG. 4 represents a cross-sectional side view of said example of a motorized machine according to the invention. When the suspended guide wheel 40 according to the invention integrates a hydraulic motor 41, the suspension system 10 is, preferably, mechanically coupled to a fixed portion of the hydraulic motor 41, i.e. to a portion of the hydraulic motor 41 not rotating along the axis of rotation of the corresponding wheel 40, namely for example the casing of the hydraulic motor 41. In particular, “mechanically coupled” means that at least one portion of the suspension system 10 and the fixed portion of the hydraulic motor 41 are mechanically integral with one other. In other words, said portion of the suspension system 10 is rigidly attached to the hydraulic motor 41.

In the present invention, particular attention is paid to the kinematic arrangement between the wheel 40, and the associated suspension system 10 and steering system 20. In the invention, the steering system 20 is in a slide-type mechanical connection with the suspension system 10 along the axis Z of the suspension system 10. In particular, the axis Z of the suspension system 10 may advantageously be substantially vertical, with the vertical direction corresponding here to the vertical direction of the motorized machine. For example, the axis Z may be slightly inclined, for example by about 4°, from the vertical.

The present invention, by implementing a slide-type connection, along the axis of travel of the suspension system, between the steering system and the suspension system, provides the advantage of substantially reducing, or even provides the advantage of eliminating, the couplings between the movements of the suspension system and the steering system according to the direction of the suspension axis. Thus, thanks to the invention, the compression and expansion movements of the suspension system do not cause steering lock of the respective wheel because there is a decoupling between the vertical movements of the suspension system and the transmission of the steering to the wheels.

Consequently, the invention advantageously makes it possible to keep the wheels parallel when the vehicle is traveling straight ahead, even when the suspension is active. This is in particular the case when driving over uneven ground, for example on stones, or when there is a slant on the ground. Keeping the wheels parallel in a straight line also makes it possible to increase the service life of the wheel tires.

The invention also makes it possible to increase the permissible ranges of the radius of the steering lock when the suspension is active. Indeed, when the vehicle is operating, if there is a coupling between the steering lock of the wheels and the oscillations of the suspension system, the movements of the suspension system may induce a force contrary to the steering lock transmitted by the steering system. The steering lock of the wheels is then limited in these conditions. The present invention makes it possible to overcome this problem, and to take advantage of a higher amplitude of the steering lock radius.

Furthermore, the present invention makes it possible to respect the Jeantaud king-pin condition. The Jeantaud king-pin condition is a geometrical condition well known in the automotive field, defining that the steering lock center of the front guide wheels must be located on the continuity of the rear axle of the machine. Compliance with the Jeantaud king-pin condition makes it possible to reduce the risk of the wheels shifting in a curve.

In summary, the present invention makes it possible to facilitate the driving handling of the motorized machine by a user, in a straight line, as well as when performing maneuvers in a curve, for example of the end-of-row turning type.

The suspension system 10 will now be described in more detail.

In reference to FIG. 4, the suspension system 10 preferably comprises a suspension pivot rod 11 and a guide sleeve 12 configured to receive the suspension pivot rod 11. The suspension pivot rod 11 and the guide sleeve 12 are preferably in a pivot-type mechanical connection sliding with each other. The present invention indeed makes it possible to implement a sliding pivot connection between the suspension pivot rod 11 and the guide sleeve 12, which is a connection that is simpler to implement from a production standpoint. Indeed, a slide-type connection between the guide sleeve 12 and the suspension pivot rod 11 is generally made by means of splines arranged between the guide sleeve 12 and the suspension pivot rod 11, which may be costly and complex to implement. The invention therefore makes it possible to avoid the use of splines, and thus makes it possible to simplify the production of the motorized machine and reduce the associated costs.

Thus, the guide sleeve 12 is preferably mechanically coupled to the chassis 30. The suspension pivot rod 11 is then preferably mechanically coupled to the corresponding wheel 40 on the one hand and to the steering system 20 on the other. As a reminder, “mechanically coupled” means that the respective elements are mechanically integral with each other. Thus, the suspension pivot rod 11 is used to transmit the steering to the corresponding wheel 40. This advantageously makes it possible to improve the robustness of the transmission of the steering.

In addition, the suspension system 10 may comprise a suspension cylinder 13 mechanically coupled on the one hand to the suspension pivot rod 11, in particular on an upper portion of the suspension pivot rod 11, and on the other hand to the suspension sleeve 12 or directly to the chassis 30 of the motorized machine. The suspension cylinder 13 is, preferably, a hydraulic cylinder, but may also be a pneumatic cylinder. The suspension cylinder 13 thus contributes to both the suspension and the damping of the corresponding wheel 40.

When the two front wheels are suspended, the two suspension systems may each comprise one suspension cylinder. The two suspension cylinders may then be dependent on each other, in particular by pooling the hydraulic circuit supplying the two suspension cylinders. For example, when one of the two wheels rolls over a bump, the fluid from the hydraulic system, especially oil, is returned from the suspension cylinder associated with the wheel rolling on the bump to the other suspension cylinder associated with the other wheel. The use of the two suspension cylinders favors the carrying out of a support on three wheels of the motorized machine while limiting travel of the wheels. This makes it possible to create a yoke function to improve the stability of the machine and favor the wheels of the motorized machine to catch on the ground.

The suspension system 10 may also conventionally comprise a spring or a set of springs (not shown in the figures).

The steering system will now be described in more detail.

As shown in FIGS. 2 to 4, in a preferred embodiment of the invention, for each of the guide wheels and suspended according to the invention, the steering system 20 comprises a main connecting rod 21 configured to transmit the steering to the corresponding wheel 40. The main connecting rod 21 is in a pivot-type mechanical connection with the chassis 30, or when it is suitable with the guide sleeve 12 of the suspension system 10 (the guide sleeve 12 being in particular attached to the chassis 30). The pivot connection may, for example, be made by means of bearings fitted on an internal face of the main connecting rod 21.

In addition, the steering system 20 comprises, for the corresponding wheel 40, a deflector rod 22 mechanically coupled to the main connecting rod 21 and oriented along the axis Z of the suspension system 10, and a secondary connecting rod 23 mechanically coupled to the suspension system 10 on the one hand and in a pivot-type mechanical connection with the deflector rod 22 on the other. The secondary connecting rod 23 may alternatively be in a slide-type mechanical connection with the deflector rod 22. The secondary connecting rod 23 is in particular attached to the suspension pivot rod 11 of the suspension system 10.

Thus, the rotation of the main connecting rod 21 around its axis will cause the deflector rode 22 to rotate about this same axis, because the deflector rod 22 is mechanically integral with the main connecting rod 21. The rotation of the deflector rod 22 will then induce the rotation of the secondary connecting rod 23 which will then transmit this movement to the suspension pivot rod 11, which will cause the corresponding wheel 40 to turn.

The assembly formed by the secondary connecting rod 23 and the suspension pivot rod 11 is in a slide-type mechanical connection, along the axis of the suspension system 10, with respect to the main connecting rod 21 and deflector rod 22 assembly. As a result, the suspension pivot rod 11 may move up and down without affecting the transmission of the steering to the corresponding wheel. As a result, the alignment of the kinematic chain formed successively by the main connecting rod, the deflector rod and the secondary connecting rod makes it possible to maintain the parallelism of the wheels in a straight line and to respect the Jeantaud king-pin condition.

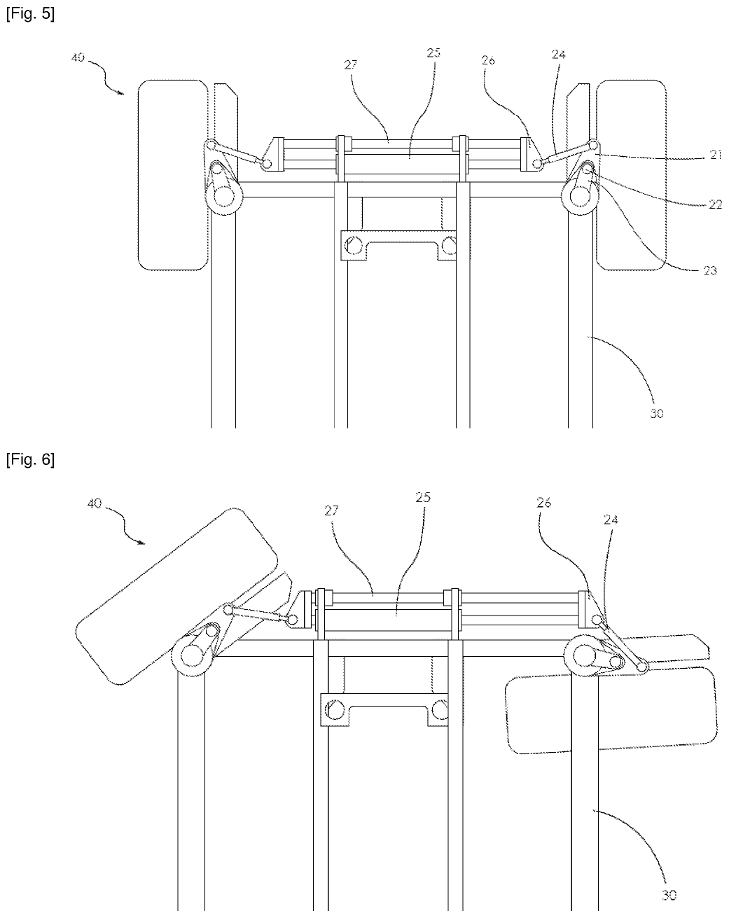

FIGS. 5 and 6 show a top view of the example of the agricultural machine according to the invention in two different configurations of steering lock of the suspended drive wheels, respectively a first configuration wherein the wheels are straight, and a second configuration wherein the wheels are steering locked (in FIG. 6, the wheels are steering locked to the maximum to the right).

In particular, the motorized machine comprises a steering cylinder 25 configured to transmit the steering to the guide wheels.

The steering system 20, for the corresponding wheel 40, may comprise a steering rod 24. The steering cylinder 25 may then transmit the steering to the guide wheels, respectively by pushing or pulling on the steering rod 24.

The steering rod 24 is then preferably in a ball joint-type mechanical connection with the main connecting rod 21 of the corresponding wheel 40. In other words, the steering cylinder 25 transmits the steering to the main connecting rod 21 through the steering rod 24.

More specifically, the steering system may comprise a connecting part 26 adapted to mechanically connect the steering cylinder 25 on the one hand and the steering rod 24 on the other. In particular, the connecting part 26 may be attached to the steering cylinder 25. The steering rod 24 may advantageously be in a ball joint-type mechanical connection with the connecting part 26.

Furthermore, it may be noted that in the context of two front suspended drive wheels according to the invention, each of the wheels is associated with a suspension system and a steering system such as described previously. In addition, a single steering cylinder is sufficient to drive both steering systems (each steering system being associated with one wheel), and therefore to steer both wheels of the high-clearance front axle.

The steering cylinder 25 is in particular attached to the chassis 30, in particular towards the center of the front axle of the motorized machine, in other words in the middle of the two front wheels. In addition, the steering cylinder 25 is preferably aligned, or substantially parallel, with a shaft connecting the two suspended drive wheels.

The steering cylinder 25 preferably consists of a double rod cylinder. The use of a double rod cylinder advantageously eliminates the need for a complex yoke-type component capable of transmitting the steering to the two steering rods directly. Also, each connecting part, respectively of each of the steering systems (associated respectively with one and the other of the two front wheels of the motorized machine), mechanically connects the double rod cylinder to the steering rod 24 of the corresponding steering system. In other words, the connecting parts are attached on either side of the steering cylinder. This configuration makes it easier to position the steering cylinder parallel to the shaft connecting the two suspended guide wheels.

In addition, the steering system may comprise a reinforcement rod 27 arranged in parallel with the steering cylinder 25 so as to enable mechanical forces to be taken up again, thereby reducing the mechanical forces transmitted through the steering cylinder 25.

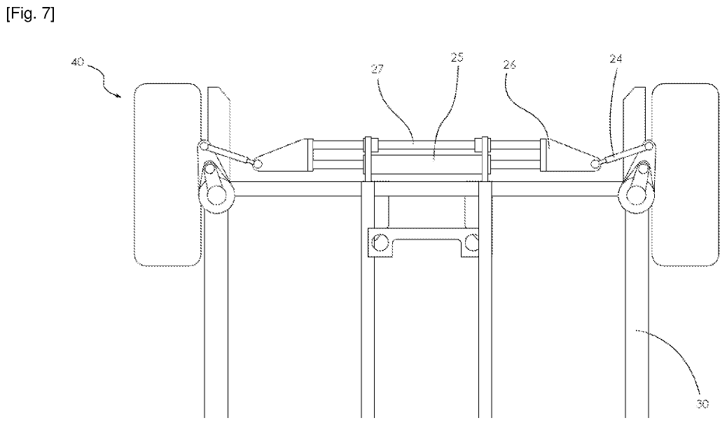

FIG. 7 shows a partial top view of another example of a motorized machine according to the invention. In this configuration, the length of the connecting parts 26 between the steering cylinder 25 and the steering rods 24 is adapted. Indeed, the steering system according to the invention makes it possible to easily adjust the connecting parts 26 to the configuration of the motorized machine in order to guarantee compliance with the Jeantaud king-pin condition.

According to another embodiment of the invention, not shown in the figures, the motorized machine could comprise a steering cylinder driving a steering yoke centered with respect to the two front wheels. Then, two steering rods could connect each of the two front wheels to the steering yoke respectively. More specifically, the steering rods could be connected to the wheels through the previously described assemblies comprising the main connecting rods, the deflector rods, and the secondary connecting rods. The movement of the yoke will thus act on the steering rods, which in turn will drive the main connecting rods. The main connecting rods will transmit the movement to the deflector rods which will drive the secondary connecting rods. The secondary connecting rods will then drive the suspension system in rotation, and finally the corresponding wheel. In this embodiment of the invention, only the upstream portion of the steering systems, namely the mechanical integration of the steering cylinder and the steering rods, is different. The previously described details of implementation of the suspension systems and the downstream portion of the steering systems, namely setting up the slide-type connection between the steering system and the suspension system, apply to this embodiment.

In summary, the mechanical integration of the suspension system and the steering system for a suspended drive wheel according to the invention allows the driver to better control and steer their vehicle. Indeed, the driver of the vehicle benefits from improved driving comfort when driving straight ahead, i.e. without having to correct the wheels of their vehicle excessively frequently or with too much effort. In addition, driving maneuvers in curves is also made easier. The present invention therefore makes it possible to avoid the occurrence of an uncontrolled steering lock phenomenon of the wheels, and allows better grip on the ground of the wheels in straight line as well as in a curve, while limiting the vibrations transmitted by the wheels to the vehicle controls when the road is rugged. Furthermore, the present invention makes it possible to limit wear of the tires of the motorized machine.

1. A motorized machine comprising a chassis, a suspension system mechanically coupled on the one hand to a wheel of the motorized machine and on the other hand to the chassis, and a steering system configured to transmit the steering to said wheel of the motorized machine through the suspension system, the steering system comprising a main connecting rod in a pivot-type mechanical connection with the chassis, a deflector rod mechanically coupled to the main connecting rod and oriented along the axis of the suspension system, and a secondary connecting rod mechanically coupled to the suspension system on the one hand and in a slide-type mechanical connection with the deflector rod on the other, so that the steering system is in a slide-type mechanic connection with the suspension system along the axis of the suspension system.

2. The motorized machine according to claim 1, wherein the axis of the suspension system is substantially vertical.

3. The motorized machine according to claim 2, the suspension system comprising a suspension pivot rod and a guide sleeve configured to receive the suspension pivot rod, wherein the guide sleeve is mechanically coupled to the chassis and is in a pivot-type mechanical connection with the main connecting rod, and in that the suspension pivot rod is mechanically coupled on the one hand to the corresponding wheel and on the other hand to the secondary connecting rod of the steering system.

4. The motorized machine according to claim 2, comprising a steering cylinder, wherein the steering system comprises a steering rod in a ball joint-type mechanical connection with the main connecting rod, the steering cylinder being configured to transmit the steering to the main connecting rod through the steering rod.

5. The motorized machine according to claim 1, forming a four-wheeled motorized machine, the motorized machine comprising two suspension systems, two steering systems, each of the two suspension systems and each of the two steering systems being respectively associated with one and the other of the two front wheels of the motorized machine.

6. The motorized machine according to claim 4, forming a four-wheeled motorized machine, the motorized machine comprising two suspension systems, two steering systems, each of the two suspension systems and each of the two steering systems being respectively associated with one and the other of the two front wheels of the motorized machine.

7. The motorized machine according to claim 6, wherein the steering cylinder consists of a double rod cylinder, each of the steering systems, associated respectively with one and the other of the two front wheels of the motorized machine, comprising a connecting part mechanically connecting the double rod cylinder to the corresponding steering rod.

8. The motorized machine according to claim 7, wherein the steering cylinder is substantially arranged parallel to a shaft connecting the two front wheels of the motorized machine.

9. The motorized machine according to claim 1, forming a high-clearance machine for vine crops.
